(19) United States
(12) Patent Application Publication
(10) Pub. No.: US 2009/0308068 A1
(43) Pub. Date: Dec. 17, 2009

(54) CONTROL CIRCUIT FOR CONSTRUCTION MACHINE

(75) Inventor: Kazunori Yoshino, Tokyo (JP)

Correspondence Address: DARBY & DARBY P.C., P.O. BOX 770, Church Street Station, New York, NY, 10008-0770, US

(73) Assignee: SHIN CATERPILLAR MITSUBISHI LTD, TOKYO (JP)

(21) Appl. No.: 10/596,478

(22) PCT Filed: Jul. 11, 2005
(86) PCT No.: PCT/JP2005/012731

§ 371 Date: Jun. 14, 2006

(30) Foreign Application Priority Data
Dec. 28, 2004 (JP) 2004-380575

(51) Int. Cl. F15B 11/028

(52) U.S. Cl. 60/468

(57) ABSTRACT

Boom operating valves, a stick operating valve, etc. for respectively controlling hydraulic fluid fed from hydraulic pumps to boom cylinders, a stick cylinder, and other actuators are provided with center by-pass lines Cb. A stick-in meter-out load pressure compensating valve is provided on a rod-side return line, which extends from a rod side of the stick cylinder to a tank. A pressure sensor is provided at the rod side of the stick cylinder so as to detect pressure of hydraulic fluid fed to the rod side. The center by-pass line Cb associated with the stick operating valve is provided with an electromagnetic relief valve for controlling the pressure in the portion of the center bypass line downstream from the stick operating valve so as to increase the pressure in accordance with.

### CROSS-REFERENCE TO PRIOR APPLICATION

This application is a U.S. national phase application under 35 U.S.C. §371 of International Patent Application No. PCT/JP 2005/012731, filed Jul. 11, 2005, and claims the benefit of Japanese Application No. 2004-380575, filed Dec. 28, 2004. The International Application has not published yet at the time of filing of this application.

### TECHNICAL FIELD

The present invention relates to a control circuit that is designed to be provided in a construction machine and includes an open center circuit provided with a center by-pass line.

### BACKGROUND ART

FIG. 5 shows a conventional hydraulic circuit that is used in a hydraulic excavator (swing type) to control right and left brake-equipped travel motors 11,12, a swing motor 13, and various hydraulic cylinders. The aforementioned travel motors 11,12 serve to drive a lower structure (crawler belts). The swing motor 13 serves to rotate a superstructure on a lower structure. The hydraulic cylinders serve to operate a work equipment 14 (shown in FIG. 6) attached to the superstructure.

As shown in FIG. 6, the work equipment 14 includes a boom 15, a stick 16, and a bucket 17 that are serially connected to one another by means of pins 21,22,23. The boom 15, the stick 16, and the bucket 17 are adapted to be rotated by boom cylinders 24, a stick cylinder 25, and a bucket cylinder 26 respectively. In FIG. 6, the center of gravity of each component is represented by a black dot.

Referring again to FIG. 5, hydraulic fluid discharged from hydraulic pumps 28, which are adapted to be driven by an in-vehicle engine 27, is fed to various hydraulic actuators, i.e. the hydraulic motors 11,12,13 and the hydraulic cylinders 24,25,26, through operating valves 111,121,131,241,242,251,252,261 corresponding to these hydraulic actuators.

Each operating valve 111,121,131,241,242,251,252,261 is controlled by operating an operation lever of the pilot-operated valve (what is widely called a remote control valve) that corresponds to the operating valve so that the direction and magnitude of displacement of the spool incorporated in each respective operating valve is controlled by pilot pressure output from the pilot-operated valve in response to the stroke of the operation lever.

In the drawing, Ps denotes a hydraulic fluid feeding line that communicates with a discharge line of each hydraulic pump 28, which is a variable delivery pump. The symbol T denotes a tank line that communicates with a tank 29 and serves to discharge hydraulic fluid. The symbol Cb denotes a center by-pass line that passes through a number of operating valves selected from among operating valves 111,121,131,241,242,251,252,261 and is adapted to become open when the operating valves associated therewith are at a neutral position.

An orifice 31 and a relief valve 32 that are connected in parallel with each other are provided at the furthest end of each center by-pass line Cb and serve to retrieve negative flow control pressure (hereinafter referred to as “negative control pressure”). The upstream side of each orifice 31 and relief valve 32 communicates through a negative flow control line (hereinafter referred to as “negative control line” ) 33 with a pump regulator 35 that serves to control a delivery control means 34, such as a swash plate, of the corresponding hydraulic pump 28. The downstream side of each orifice 31 and relief valve 32 communicates with the tank 29.

The closer any one of the operating valves 111,121,131,241,242,251,252,261 is to the neutral position, the higher the pressure in the corresponding negative control line 33, the pressure in which is hereinafter referred to as “negative control pressure”. Each pump regulator 35 is adapted to prevent unnecessary supply of hydraulic fluid by controlling the corresponding delivery control means 34, such as a swash plate, so that the higher the negative control pressure, the lower the pump discharge rate.

There are various conventionally known examples of a hydraulic excavator incorporating an open-center type control circuit system that includes such center by-pass lines Cb (e.g. Japanese Laid-open Patent Publication No. 9-151487 (page 5, FIG. 1)) It is common practice with a hydraulic excavator of this type for tuning of horizontal leveling equipped with a standard bucket to be performed at the time of development of a working prototype.

After the hydraulic excavator is purchased, however, it is often the case that the end user replaces the standard bucket with a large, heavy-weight slope bucket that corresponds to how the hydraulic excavator will be used.

This happens frequently, particularly in cases where the widest possible area of the ground surface has to be flattened within a limited period of time, when tilling a field, or preparing a housing site.

If such is the case, should a lever be pulled in order to perform horizontal leveling when the work equipment 14 is in the fully extended position as shown in FIG. 6(a), the machine is started up with all of the holding pressures at the head-side of the boom cylinders and the rod-side of the stick cylinder being high.

As a result, as shown in FIG. 7, a greater degree of operation of a boom operation lever is required to reach the starting point for the boom cylinders to actually raise the boom than is required when the standard bucket is used, resulting in an operation range substantially narrower than when performing fine operation with the standard bucket.

Furthermore, the greater the operation lever stroke is to reach the starting point for fine operation for boom raising, i.e. the degree of operation of the lever required to reach the aforementioned starting point compared to when the standard bucket is used, the more difficult it is to synchronize boom raising with lowering the stick, resulting in poorer horizontal leveling performance.

As shown in FIG. 8, when extending the stick cylinder for stick-in operation, the holding pressure P_{rod} at the rod side of a stick cylinder operating valve 251, i.e. the side linked with the rod side of the stick cylinder 25, is increased by the amount corresponding to the increase in the weight of the bucket. Therefore, given that the aperture area of a passage from the rod-side of the stick cylinder operating valve 251 to the tank line T is A_{rod meter out}, the pressure at the tank side is Pₜ, and the density of the hydraulic fluid is ρ, the gain of the rise of the rod-side meter-out flow rate Q increases by the amount corresponding to the increase in the holding pressure P_{rod} in accordance with the equation:

Q=C*A_{rod meter out}*√{2(P_{rod}−Pₜ)/ρ}.

Therefore, fine operability deteriorates even when the stick cylinder 25 is extended alone. Moreover, the aforementioned increase in degree of operation of a boom operation lever required to reach the starting point for the boom cylinders to actually raise the boom occurring simultaneously with deterioration of fine operability for extending the stick cylinder makes adjustment by the operation lever extremely difficult. As a result, as shown in FIG. 9, when the hydraulic excavator is equipped with a heavy bucket, a greater undulation phenomenon D than in the case with a standard bucket occurs around a starting point for horizontal leveling, substantially impairing the machine's ground leveling performance.

To be more specific, when pulling the work equipment 14 of the hydraulic excavator in the fully extended position as shown in FIG. 6(a) inward in order to horizontally leveling soft ground as shown in FIG. 6(b) (in other words in the course of light load operation at the head side of the stick cylinder), the respective centers of gravity of the stick 16 and the bucket 17 (represented by black dots) are horizontally spaced apart from the pin 22 at the distal end of the boom. That is, gravitational force produces a great torque around the pin 22 at the distal end of the boom, resulting in a high holding pressure at the rod side 25r of the stick cylinder 25. As a result, a flow rate gain in a return path from the rod side 25r of the stick cylinder 25 to the tank is high with respect to the valve stroke.

Therefore, when the stick cylinder 25 is in such a position as shown in FIG. 6(a), it is difficult to achieve fine control of extending speed of the stick cylinder 25 or precise synchronization with inching up the boom. As shown in FIG. 9, the heavier the bucket, the greater the undulation phenomenon D, which is a large undulating motion of the bucket tip 17a, often causing complaints from an operator.

Furthermore, when lifting a load, too, operational performance may be impaired due to the weight of the load for the same reason described above, because load lifting calls for frequent boom raising and stick-out operation.

### SUMMARY OF THE INVENTION

Even if tuning has already been done by using a standard bucket, depending on the weight and the type of the bucket attachment, a conventional hydraulic excavator operates at different operation speeds and operation timing between the boom cylinders and the stick cylinder in response to identical operation commands, resulting in poor operability.

This may lead to the user complaining about problems, such as unsatisfactory ground leveling. Whenever such a complaint is made, it may become necessary to perform tuning design, production, or an evaluation test of a spool notch. This is very inefficient.

As those skilled in the art have long been resigned to regarding this problem as an intrinsic characteristic of an open center control circuit, this problem has remained unsolved as a potential drawback of an open center circuit in contrast to its merits, such as swing force modulation.

A conventional control circuit presents another problem in that as it is impossible to eliminate the influence of load on operational performance in load hanging work, performance of load hanging work tends to rely on the skill of the operator, resulting in an increased possibility of an accident or other problems resulting from human error.

In order to solve the above problems, an object of the invention is to provide a control circuit for a construction machine, wherein the control circuit includes an open center circuit and ensures, even when using a bucket of a different weight, a compatible level of operability to that obtained by tuning with a standard bucket.

The present invention relates to a control circuit for a construction machine, the control circuit including an open center circuit provided with center bypass lines passing through at least a boom operating valve, a stick operating valve, and a bucket operating valve that are adapted to control hydraulic fluid fed from hydraulic pumps to boom cylinders, a stick cylinder, and a bucket cylinder and subsequently returned through return lines to a tank, the aforementioned boom cylinders serving to operate a boom, the stick cylinder serving to operate a stick connected to the distal end of the boom, and the bucket cylinder serving to operate a bucket connected to the distal end of the stick, wherein the control circuit further includes a pressure-compensating flow control valve provided on a return line for hydraulic fluid returned from a rod side of the stick cylinder to the tank; a pressure sensor for detecting pressure of hydraulic fluid fed to a head side of the boom cylinders; and a pressure control valve for controlling a portion of the center bypass line that passes through the boom operating valve so as to increase the pressure in accordance with an increase in the pressure detected by the pressure sensor, the portion being downstream from the boom operating valve.

The present invention relates to a control circuit for a construction machine as described above, wherein the control circuit further includes a pressure sensor for detecting pressure of hydraulic fluid fed to the rod side of the stick cylinder, and a pressure control valve for controlling a portion of the center bypass line that passes through the stick operating valve so as to increase the pressure in accordance with an increase in the pressure detected by the pressure sensor, the portion being downstream from the stick operating valve.

The present invention relates to a control circuit for a construction machine as described above wherein each pressure control valve is integrated with an orifice and a relief valve so as to form a negative flow control load pressure compensating valve, the orifice and the relief valve serving to retrieve negative flow control pressure from the corresponding center bypass line in order to control pump discharge rate.

The control circuit for a construction machine as embodied above, wherein the pressure-compensating flow control valve includes a spring for setting a differential pressure, and a pressure compensation deactivation portion that serves to increase the set load of the spring in accordance with increase in the load pressure applied to the head side of the stick cylinder, and, when the load pressure to the head side is a predetermined level or higher, increase the set load of the spring to such a level as to deactivate pressure compensation of flow control.

According to the present invention even in a state where a heavy-weight bucket is attached, meter-out flow control by the pressure-compensating flow control valve ensures the stick is lowered at a stable speed during stick-in operation by preventing change in the descending speed of the stick, and the pressure sensor and the pressure control valve ensure stable flow characteristics by generating a boom holding pressure in the center bypass line so as to prevent change in a boom raising flow modulation curve regardless of changes in load pressure. Therefore, precise stick-descending speed and boom-raising speed as commanded can be achieved, resulting in an improved performance of horizontal leveling, regardless of the type of the bucket. Furthermore, by eliminating the necessity for tuning tests on operating valves to improve performance of horizontal leveling for each bucket weight, the invention described above not only eliminates the trouble and cost of such tests but also improves reliability of the product.

According to the present invention in the course of lifting a load, when initiating simultaneous operation of boom raising by hydraulic fluid fed to the head side of the boom cylinders and stick-out operation by hydraulic fluid fed to the rod side of the stick cylinder, the pressure sensor that serves to detect pressure at the head side of the boom cylinders and the pressure control valve that serves to control the pressure in the portion of the corresponding center bypass line downstream from the boom operating valve so as to increase the pressure in accordance with an increase in the pressure detected by the pressure sensor ensure a constant lever position for initiating boom raising as well as sufficient fine operation range regardless of the weight of the load, and also enable compensation for the gain of the rise of flow rate with respect to the valve stroke. At the same time, the pressure sensor that serves to detect pressure at the rod side of the stick cylinder and the pressure control valve that serves to control the pressure in the portion of the center bypass line downstream from the stick operating valve so as to increase the pressure in accordance with an increase in the pressure detected by the pressure sensor ensure a constant lever position for initiating retraction of the stick cylinder as well as sufficient fine operation range regardless of the weight of the load, and also enable compensation for the gain of the rise of flow rate with respect to the valve stroke. As a result, load lifting can be performed with improved accuracy and cycle time. Furthermore, it is also possible to prevent sudden changes in boom cylinder speed or stick cylinder speed or inching performance deterioration.

According to the present invention each negative flow control load pressure compensating valve is formed by integrating a pressure control valve for controlling center bypass line pressure with an orifice and a relief valve that serve to retrieve negative flow control pressure. By thus simultaneously incorporating these components in each center bypass line, the present invention is capable of reducing not only the task of production of the control circuit but also the space for installation of these components.

According to the present invention the pressure compensation deactivation portion is adapted to control the set load of the spring so as to increase the set load when the load pressure at the head side of the stick cylinder increases. Should the load pressure at the head side reach a predetermined level under a heavy load, for example during excavation, the pressure compensation deactivation portion increases the set load of the spring to a sufficient level, thereby setting a considerably high effective differential pressure of the spool at the meter-out side so that the set flow of the pressure-compensating flow control valve as a flow control valve becomes higher in appearance than the actual return flow at the rod side of the stick cylinder, the aforementioned actual return flow being dependent on the maximum flow of the corresponding hydraulic pump. Therefore, in this state, the pressure-compensating flow control valve functions as a regular throttle valve and performs meter-out flow control with normal throttling because its ability for compensating for the pressure at the rod side of the stick cylinder does not function.

### BRIEF DESCRIPTION OF THE DRAWINGS

FIG. 1 is a circuit diagram showing a stick cylinder control section of a control circuit for a construction machine according to an embodiment of the present invention.

FIG. 2 is a circuit diagram showing a boom cylinder control section of the control circuit.

FIG. 3 is a characteristic diagram showing flow control characteristics of a stick-in meter-out load pressure compensating valve, wherein (a) and (b) show cases where a rod pressure is 100 kgf/cm² and 200 kgf/cm², respectively.

FIG. 4 represents observed data showing the locus of the bucket tip in horizontal leveling performed by using the aforementioned control circuit.

FIG. 5 is a circuit diagram showing a conventional control circuit for a construction machine.

FIG. 6 is a schematic illustration of a work equipment of a construction machine, wherein (a) and (b) respectively show the positions of the work equipment when starting horizontal leveling and during horizontal leveling.

FIG. 7 is a characteristic diagram showing changes in the extending speed of the boom cylinders.

FIG. 8 is a schematic illustration showing changes in the extending speed of the stick cylinder.

FIG. 9 represents observed data showing the locus of the bucket tip in horizontal leveling performed by using the conventional control circuit.

### DETAILED DESCRIPTION OF THE INVENTION

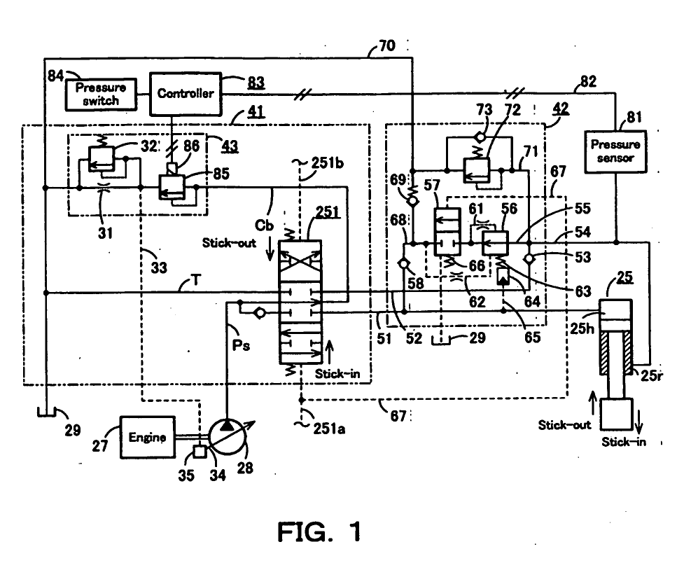

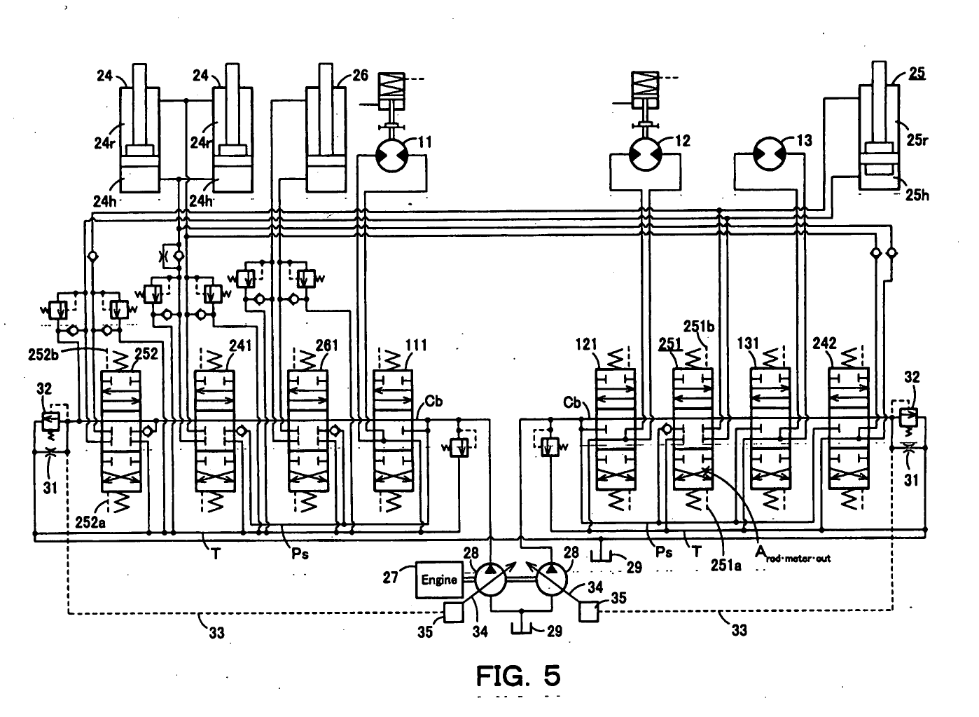

Next, the present invention is explained hereunder, referring to an embodiment thereof shown in FIGS. 1 through 4. The circuit shown in FIG. 5 is a basic circuit on which the present invention is based. The elements corresponding to those in FIG. 5 are identified with the same reference symbols, explanation of which may be omitted herein. As the circuits for the travel systems, the swing system, and the bucket system, are the same as those of the conventional circuit shown in FIG. 5, their explanations, too, are omitted.

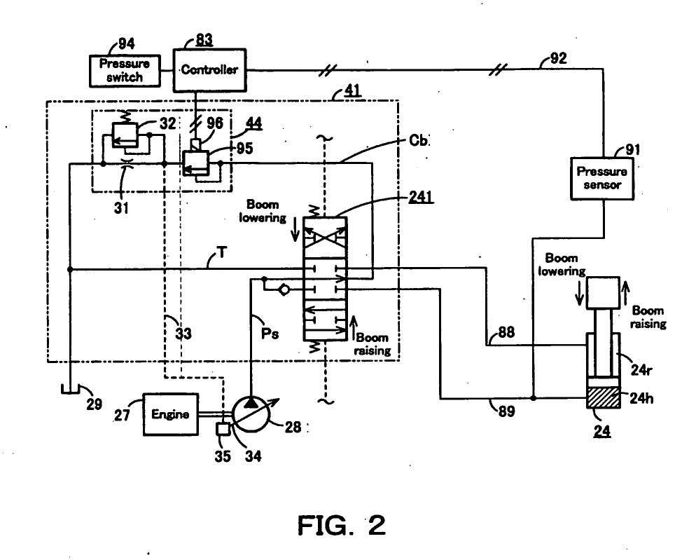

FIGS. 1 and 2 illustrate a load pressure compensation system in a 2-pump open center system shown in FIG. 5. This load pressure compensation system is capable of partial load pressure compensation while making use of the merits of the conventional open center system, thereby improving ground leveling ability and productivity when using a heavy-weight bucket, as well as lifting-operability when hoisting a load.

In FIGS. 1 and 2, numeral 41 denotes a control valve incorporating the spools of various operating valves 111,121,131,241,242,251,252,261 shown in FIG. 5.

In addition to the aforementioned control valve 41, FIG. 1 shows a stick-in meter-out load pressure compensating valve 42 that serves as a pressure-compensating flow control valve for compensating for load pressure of the meter-out flow rate of a stick cylinder 25 during stick-in operation.

The control valve 41 also includes a negative flow control load pressure compensating valve (hereinafter referred to as negative control load pressure compensating valve) 43 for compensating for load pressure at the stick-out side.

As shown in FIG. 2, the control valve 41 further includes a negative control load pressure compensating valve 44 for compensating for load pressure at the boom-raising side.

As shown in FIG. 1, one of the output ports of a stick operating valve 251 is connected to the head side 25h of the stick cylinder 25 through a head-side feed/discharge line 51, and the other output port of the stick operating valve 251 communicates with the rod side 25r of the stick cylinder 25 through a rod-side feed/discharge line 52 and a line 54, which are connected through a load hold check valve 53.

The aforementioned stick-in meter-out load pressure compensating valve 42 comprises a rod-side return line 55 serving as a return line, as well as a pressure compensating valve 56 for controlling differential pressure, a flow control valve 57, and a recovery check valve 58. The rod-side return line 55 branches off at some point along the line 54, which extends from the load hold check valve 53 to the rod side 25r of the stick cylinder 25. The pressure compensating valve 56, the flow control valve 57, and the recovery check valve 58 are serially arranged and disposed between the rod-side return line 55 and the aforementioned head-side feed/discharge line 51.

A line 61 for detecting pressure at the upstream side of the flow control valve 57 is connected to one side of the pressure compensating valve 56, and a line 62 for detecting pressure at the downstream side of the flow control valve 57 is connected to the other side of the pressure compensating valve 56. A spring 63 for setting a differential pressure is in contact with the other side of the pressure compensating valve 56 so that the spring 63 sets a differential pressure between the upstream and downstream sides of the flow control valve 57.

A pressure compensation deactivation portion 64 in the shape of a cylinder piston is provided in association with the spring 63 of the pressure compensating valve 56 and serves to adjust the differential pressure between the upstream and downstream sides of the flow control valve 57 by increasing the set load of the spring 63 in accordance with increase in the load pressure applied to the head side 25h of the stick cylinder 25. The pressure compensation deactivation portion 64 also serves to increase the set load of the spring 63 to such a level as to deactivate the pressure compensation of flow control when the load pressure applied to the head side is a predetermined level or higher. A head-side pressure detection line 65 drawn out from the head-side feed/discharge line 51 is directed into the cylinder of the pressure compensation deactivation portion 64.

The cylinder of the pressure compensation deactivation portion 64 incorporates a piston for controlling the set load of the spring 63 by functioning in response to the load pressure conveyed from the head side 25h of the stick cylinder 25 through the head-side pressure detection line 65. In other words, should the load pressure at the head side 25h reach a predetermined level, the pressure compensation deactivation portion 64, which is adapted to increase the set load of the spring 63 in conjunction with the increase in the load pressure at the head side 25h of the stick cylinder 25, increase the set load of the spring 63 to such a level that the function of pressure compensation is deactivated.

One end of the flow control valve 57 is in contact with a return spring 66, and a pilot pressure line 67 is connected to the opposite end of the flow control valve 57. The pilot pressure line 67 branches off from a pilot pressure line 251a extending from the cylinder extending side, i.e. stick-in side, of the stick cylinder operating valve 251. Furthermore, the other side of the stick cylinder operating valve 251 is connected to a pilot pressure line 251b of the cylinder retracting side, i.e. stick-out side.

A line 68 provided downstream from the flow control valve 57 communicates with a return line 70 through a back pressure check valve 69 that serves to generate a given, constant back pressure at this portion. The back pressure check valve 69 is adapted to set back pressure of return fluid by means of set load of a spring that pushes a check valve body against a seat. The aforementioned return line 70 is connected to the tank 29.

A line 71 branches off from the line 54 connected to the rod side 25r of the stick cylinder 25. The line 71 is connected to the return line 70 through a line relief valve 72 and a check valve 73, which are connected in parallel with each other. The line relief valve 72 serves to protect the line by becoming connected to the line 71 should an abnormally high pressure that may damage the line be generated at the rod side 25r of the stick cylinder 25.

As shown in FIG. 1, the line 54 connected to the rod side 25r of the stick cylinder 25 is provided with a pressure sensor 81, which is connected through an electrical signal line 82 to an input section of a controller 83. A pressure switch 84 is also connected to the input section of the controller 83. The output section of the controller 83 is connected to the aforementioned negative control load pressure compensating valve 43 at the stick-out side.

The negative control load pressure compensating valve 43 comprises an orifice 31, a relief valve 32, and an electromagnetic relief valve 85. The orifice 31 and the relief valve 32 are connected in parallel with each other. The electromagnetic relief valve 85 serves as a pressure control valve. The orifice 31 and the relief valve 32 are included in a center by-pass line Cb that passes through the stick operating valve 251. A negative flow control line (hereinafter referred to as “negative control line”) 33 is drawn from some point along the center by-pass line Cb upstream of the orifice 31 and relief valve 32. The electromagnetic relief valve 85 is disposed further upstream of the point from which the negative control line 33 is drawn. Therefore, the output section of the controller 83 is connected to a solenoid 86 of the electromagnetic relief valve 85.

As shown in FIG. 2, a rod-side feed/discharge line 88 and a head-side feed/discharge line 89 are respectively connected to the rod side 24r and head side 24h of the boom cylinders 24. The head-side feed/discharge line 89 is provided with a pressure sensor 91, which is connected through an electrical signal line 92 to the input section of the controller 83. A pressure switch 94 is also connected to the input section of the controller 83. The output section of the controller 83 is connected to the aforementioned negative control load pressure compensating valve 44 at the boom-raising side.

The negative control load pressure compensating valve 44 comprises an orifice 31 and a relief valve 32, which are connected in parallel with each other, and an electromagnetic relief valve 95 that serves as a pressure control valve. The orifice 31 and the relief valve 32 are included in a center by-pass line Cb that passes through a boom operating valve 241. A negative control line 33 is drawn from some point along the center by-pass line Cb upstream of the orifice 31 and relief valve 32. The electromagnetic relief valve 95 is disposed further upstream of the point from which the negative control line 33 is drawn. Therefore, the output section of the controller 83 is connected to a solenoid 96 of the electromagnetic relief valve 95.

Next, functions and effects of the embodiment shown in FIGS. 1 and 2 are explained hereunder.

Horizontal Leveling

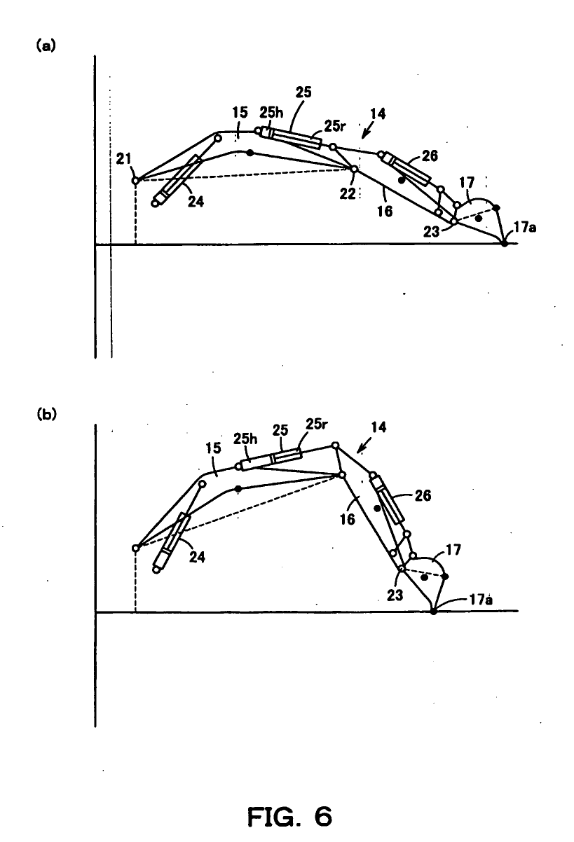

When performing horizontal leveling, as shown in FIG. 6(a) and (b), the boom cylinders 24 are operated to raise the boom while the stick cylinder 25 is operated to extend the stick (stick-in operation).

At that time, regarding the functions of the components shown in FIG. 1, when pilot pressure for extending the stick cylinder is fed to the pilot pressure line 251a, the stick cylinder operating valve 251 is changed over to a lower chamber position, and the pilot pressure that is fed through the pilot pressure line 67 to extend the stick cylinder changes over the flow control valve 57 of the stick-in meter-out load pressure compensating valve 42 to a channel-communicating position so that hydraulic fluid discharged from the corresponding hydraulic pump 28 is fed through the head-side feed/discharge line 51 to the head side 25h of the stick cylinder 25 and that the fluid discharged from the rod side 25r is returned to the tank 29 through the flow control valve 57 and other relevant components. As a result, the stick cylinder 25 is extended.

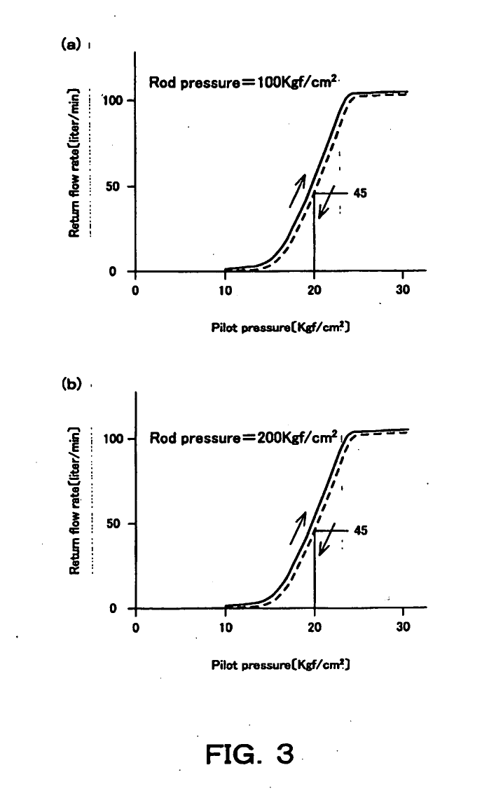

Throughout the course of extending the stick cylinder 25, pressure resulting from the flow passing through the flow control valve 57 (the return flow) is compensated for by the pressure compensating valve 56 as shown in FIG. 3. To be more specific, should the stick cylinder operating valve 251 be pilot-operated in such a direction as to perform stick-in operation in order to initiate horizontal leveling when the stick is in the position shown in FIG. 6(a) and equipped with a heavy bucket, the pressure at the head side 25h of the stick cylinder 25 so that the set load of the spring 63 is controlled at a low level by means of the pressure compensation deactivation portion 64, which is operated by head-side load pressure retrieved through the head-side pressure detection line 65. As a result, the differential pressure between the upstream and downstream sides of the flow control valve 57 is also controlled at a low level. Therefore, even if the pressure of return fluid discharged from the rod side 25r of the stick cylinder 25 is high due to the heavy weight of the bucket, the flow rate of the hydraulic fluid passing through the flow control valve 57 is limited based on the small differential pressure between the upstream and downstream sides of the flow control valve 57, thereby preventing the extending speed of the stick from increasing, which would otherwise result from the heavy weight of the bucket. As a result, the characteristics in cases where a heavy bucket is used, which characteristics are represented by the solid line in FIG. 8, can be returned to a level similar to those shown in the dotted line, which represents characteristics in cases where a standard bucket is used.

Should the pressure in the head-side feed/discharge line 51 be higher than the pressure in the line 68 during extending operation of the stick cylinder 25, the recovery check valve 58 causes all the hydraulic fluid at the rod side 25r to drain through the pressure compensating valve 56, the flow control valve 57, and the back pressure check valve 69 into the return line 70 so that the hydraulic fluid in the amount corresponding to the degree of aperture of the spool of the flow control valve 57 is discharged from the rod side 25r.

Should the hydraulic fluid fed from the hydraulic pump 28 become insufficient and voiding at the head side 25h become imminent during the aforementioned operation, a part of the return fluid from the rod side 25r of the stick cylinder 25 to the return line 70 is recovered and fed from the line 68 through the recovery check valve 58 to the head-side feed/discharge line 51, thereby preventing voiding, partly because a part of the return fluid is under back pressure due to resistance from the back pressure check valve 69. At that time, as the cylinder head-side load pressure retrieved through the head-side pressure detection line 65 is not high enough to cause voiding, the pressure compensation deactivation portion 64 controls the set load of the spring 63 at a low level to also limit the differential pressure between the upstream and downstream sides of the flow control valve 57 to a low level.

At the same time, regarding the functions of the components shown in FIG. 2, a boom cylinder operating valve 241 is changed over to a lower chamber position so that hydraulic fluid discharged from the corresponding hydraulic pump 28 is fed through the head-side feed/discharge line 89 to the head side 24h of the boom cylinders 24 and that the fluid discharged from the rod side 24r is returned to the tank 29 through the rod-side feed/discharge line 88, the boom cylinder operating valve 241, and the tank line T.

At that time, the boom head pressure generated in the head-side feed/discharge line 89 is detected by the pressure sensor 91 and conveyed to the controller 83 so that the controller 83 feeds an electrical signal corresponding to the boom head pressure to the solenoid 96 of the electromagnetic relief valve 95 of the negative control load pressure compensating valve 44, thus enabling the electromagnetic relief valve 95 to increase the pressure in the center bypass line Cb in accordance with the boom head pressure.

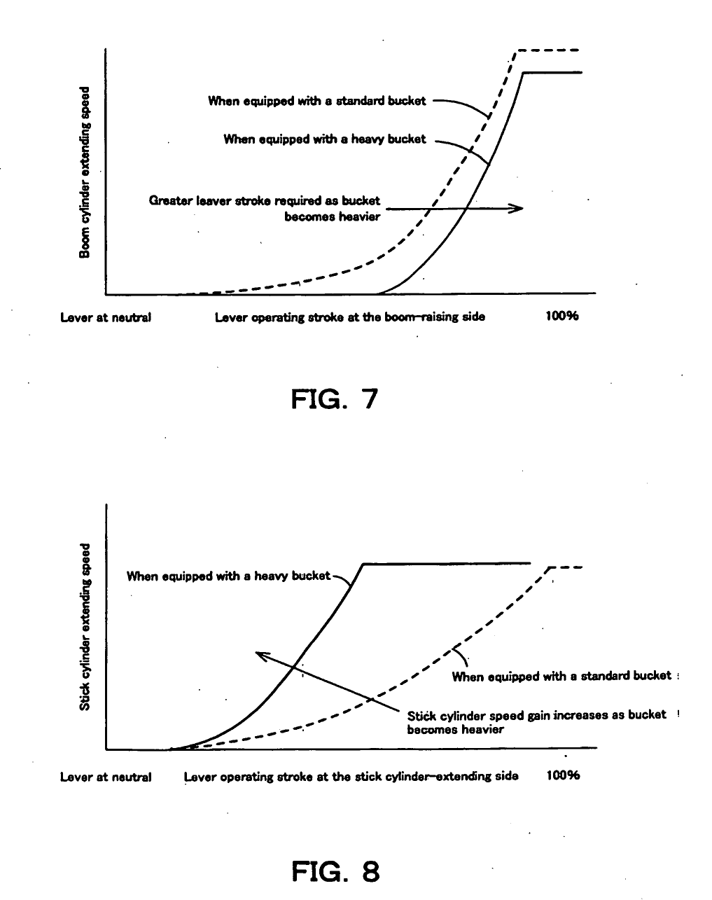

To be more precise, the hydraulic fluid discharged from the hydraulic pump 28 is distributed into the head-side feed/discharge line 89 and the center bypass line Cb according to the valve stroke of the boom cylinder operating valve 241, with the amount of flow being released into the center bypass line Cb increasing in proportion to the load pressure in the head-side feed/discharge line 89. However, as the load pressure in the center bypass line Cb is increased by the electromagnetic relief valve 95 in accordance with the boom head pressure in order to compensate for the pressure so as to generate a boom holding pressure in the center bypass line Cb, the boom raising flow that corresponds to the command signal, i.e. the valve stroke, of the boom cylinder operating valve 241 is fed to the head side 24h of the boom cylinders 24 so that a desired speed for extending the boom cylinders is ensured regardless of the load applied to the boom when a heavy bucket is used. As a result, the characteristics in cases where a heavy bucket is used, which characteristics are represented by the solid line in FIG. 7, can be returned to a level similar to those shown in the dotted line, which represents characteristics in cases where a standard bucket is used.

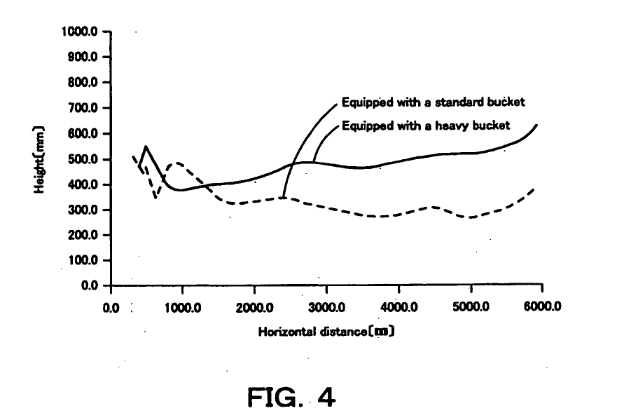

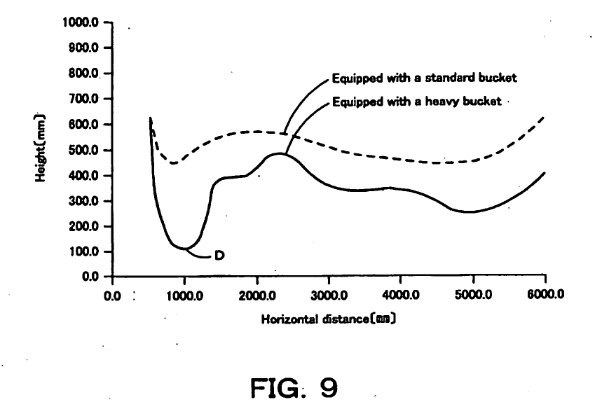

As described above, even when a heavy-weight slope bucket is used in place of a standard bucket, the stick-in meter-out load pressure compensating valve 42 and the negative control load pressure compensating valve 44 at the boom-raising side simultaneously function so that the pressure at the head side 24h of the boom cylinders 24 is detected by the pressure sensor 91, a predetermined electric current is fed from the controller 83 to the negative control load pressure compensating valve 44 in the bypass portion provided downstream from the boom operating valve 241, and a boom holding pressure is generated in the center bypass line Cb. This configuration not only prevents change in a boom raising flow modulation curve regardless of changes in load pressure, thereby ensuring stable flow characteristics, but also, as explained above, ensures the stick is lowered at a stable speed during stick-in operation by preventing change in descending speed of the stick by means of meter-out flow control by the stick-in meter-out load pressure compensating valve 42 even in a state where a heavy bucket is attached. The invention is thus effective in preventing undulation phenomenon D of the bucket tip (see FIG. 9) from occurring when starting horizontal leveling with a heavy bucket as shown in FIG. 4. In other words, satisfactory horizontal leveling ability is ensured regardless of different conditions surrounding use of various buckets.

Crane Operation

When performing crane operation to lift a load attached to a bucket 17, the boom cylinders 24 are operated to raise the boom while the stick cylinder 25 is operated to retract the stick (stick-out operation).

At that time, regarding the functions of the components shown in FIG. 1, when pilot pressure for retracting the stick cylinder is fed to the pilot pressure line 251b, the stick cylinder operating valve 251 is changed over to an upper chamber position so that hydraulic fluid discharged from the corresponding hydraulic pump 28 is fed through the rod-side feed/discharge line 52, load hold check valve 53, and the line 54, to the rod side 25r of the stick cylinder 25 and that the fluid returned from the head side 25h is returned to the tank 29 through the head-side feed/discharge line 51, the stick cylinder operating valve 251, and the tank line T.

At that time, the stick rod pressure generated in the rod side 25r of the stick cylinder 25 is detected by the pressure sensor 81 and conveyed to the controller 83 so that the controller 83 feeds an electrical signal corresponding to the stick rod pressure to the solenoid 86 of the electromagnetic relief valve 85 incorporated in the negative control load pressure compensating valve 43 for compensating for load pressure at the stick-out side, thus enabling the electromagnetic relief valve 85 to increase the pressure in the center bypass line Cb in accordance with the stick rod pressure.

To be more precise, the hydraulic fluid discharged from the hydraulic pump 28 is distributed into the rod-side feed/discharge line 52 and the center bypass line Cb according to the valve stroke of the stick cylinder operating valve 251, with the amount of flow being released into the center bypass line Cb increasing in proportion to the load pressure in the rod-side feed/discharge line 52. However, as the load pressure in the center bypass line Cb is increased by the electromagnetic relief valve 85 in accordance with the stick rod pressure in order to compensate for the pressure so as to generate a stick holding pressure in the center bypass line Cb, the boom raising flow that corresponds to the command signal, i.e. the valve stroke, of the stick cylinder operating valve 251 is fed to the rod side 25r of the stick cylinder 25 so that a desired speed for retracting the stick cylinder is ensured regardless of the load applied to the stick when a heavy bucket is used.

At the same time, regarding the functions of the components shown in FIG. 2, in the same manner as when performing horizontal leveling, the load pressure in the center bypass line Cb is increased by the electromagnetic relief valve 95 in accordance with the boom head pressure in order to compensate for the pressure so as to generate a boom holding pressure in the center bypass line Cb. By thus compensating for the pressure, the boom raising flow that corresponds to the command signal, i.e. the valve stroke, of the boom cylinder operating valve 241 is fed to the head side 24h of the boom cylinders 24 so that a desired speed for extending the boom cylinders is ensured regardless of the load applied to the boom when a heavy bucket is used. As a result, the characteristics in cases where a heavy bucket is used, which characteristics are represented by the solid line in FIG. 7, can be returned to a level similar to those shown in the dotted line, which represents characteristics in cases where a standard bucket is used.

As described above, when performing stick-out operation, the pressure at the rod side 25r of the stick cylinder 25 is detected by the pressure sensor 81; a predetermined electric current is fed from the controller 83 to the electromagnetic relief valve of the negative control load pressure compensating valve 43 provided in the center bypass line Cb at a location downstream of the stick operating valve 251; and a stick holding pressure is generated in the center bypass line Cb. This configuration not only prevents change in a stick-out flow modulation curve regardless of changes in load pressure at the rod side of the stick cylinder 25, thereby ensuring stable flow characteristics, but also ensures a constant starting position for lever operation as is true with boom operation, as well as sufficient fine operation range. Such improvements enables the control circuit described above to enhance the lifting operability during crane operation.

Furthermore, the invention presents another benefit in that the stick-in meter-out load pressure compensating valve 42 prevents sharp descent of a load when lowering the load by stick-in operation.

Heavy Load Operation

When the work equipment 14 is under a heavy load to perform excavation or other heavy load operation, there is a high load pressure at the head side 25h of the stick cylinder 25. As this high load pressure is directed by the head-side pressure detection line 65 to the pressure compensation deactivation portion 64 and increases the set load of the spring 63 to a sufficient level, thereby setting a considerably high effective differential pressure of the flow control valve 57 at the meter-out side, the set flow of the stick-in meter-out load pressure compensating valve 42 as a pressure-compensating flow control valve becomes higher in appearance than the actual return flow at the rod side 25r of the stick cylinder 25, the aforementioned actual return flow being dependent on the maximum flow of the hydraulic pump 28. Therefore, in this state, the stick-in meter-out load pressure compensating valve 42 performs meter-out flow control with normal throttling because its ability for compensating for the pressure at the rod side 25r of the stick cylinder 25 does not function. As a result, the actual flow resistance of the return fluid discharged from the rod side 25r of the stick cylinder 25 and flowing through the stick-in meter-out load pressure compensating valve 42 to the return line 70 is reduced so that heat loss in the return line, too, is reduced, enabling improvement in actual work output by the cylinder as well as the fuel efficiency of the vehicle engine 27 that drives the hydraulic pump 28.

The effectiveness of the embodiment described above is summarized hereunder.

Horizontal Leveling Performance

Even in a state where a heavy-weight bucket is attached, meter-out flow control by the stick-in meter-out load pressure compensating valve 42 shown in FIG. 1 ensures the stick is lowered at a stable speed during stick-in operation by preventing change in the descending speed of the stick, and the pressure sensor 91 and the electromagnetic relief valve shown in FIG. 2 ensure stable flow characteristics by generating a boom holding pressure in the center bypass line Cb so as to prevent change in a boom raising flow modulation curve regardless of changes in load pressure. Therefore, precise stick-descending speed and boom-raising speed as commanded can be achieved, resulting in an improved performance of horizontal leveling, regardless of the type of the bucket.

Furthermore, regardless of the type of the bucket used for horizontal leveling, the positioning accuracy and flatness of ground leveling are improved, resulting in an increase in operation speed and, ultimately, an improved performance of horizontal leveling.

Furthermore, by eliminating the necessity for tuning tests on a spool notch or other relevant elements to improve performance of horizontal leveling for each bucket application installed by an end user himself, the embodiment described above eliminates the trouble and cost of delivering the tuned spool to the end user and reinstalling the spool. At the same time, the embodiment prevents user complaints from occurring and thereby improves reliability of the product.

Crane Operation Performance

In the course of lifting a load, when initiating simultaneous operation of boom raising by hydraulic fluid fed to the head side 24h of the boom cylinders 24 and stick-out operation by hydraulic fluid fed to the rod side 25r of the stick cylinder 25, the pressure sensor 91, which serves to detect pressure at the head side 24h of the boom cylinders 24, and the electromagnetic relief valve 95, which serves to control the pressure in the portion of the center bypass line downstream from the boom operating valve 241 so as to increase the pressure in accordance with an increase in the pressure detected by the pressure sensor 91, ensure a constant lever position for initiating boom raising as well as sufficient fine operation range regardless of the weight of the load, and are also capable of compensating for the gain of the rise of flow rate with respect to the valve stroke. At the same time, the pressure sensor 81, which serves to detect pressure at the rod side 25r of the stick cylinder 25, and the electromagnetic relief valve 85, which serves to control the pressure in the portion of the center bypass line downstream from the stick operating valve 251 so as to increase the pressure in accordance with an increase in the pressure detected by the pressure sensor 81, ensure a constant lever position for initiating retraction of the stick cylinder as well as sufficient fine operation range regardless of the weight of the load, and are also capable of compensating for the gain of the rise of flow rate with respect to the valve stroke. As a result, load lifting can be performed with improved accuracy and cycle time.

Another benefit of the embodiment lies in its capability of ensuring the safety of the working environment of the operator of the construction machine and other workers in the vicinity by preventing sudden changes in boom cylinder speed or stick cylinder speed or inching performance deterioration.

Furthermore, when suspending a load by means of the stick cylinder, the embodiment described above is capable of preventing changes in descending speed of the load regardless of its weight, thereby preventing a sharp descent of the load.

Performance of General Excavation, etc.

The pressure compensation deactivation portion 64 is adapted to control the set load of the spring 63 so as to increase the set load when the load pressure at the head side 25h of the stick cylinder 25 increases. Should the load pressure at the head side 25h reach a predetermined level under a heavy load, for example during heavy excavation by stick-in operation, the pressure compensation deactivation portion 64 increases the set load of the spring 63 to a sufficient level, thereby setting a considerably high effective differential pressure of the flow control valve 57 at the meter-out side so that the set flow of the stick-in meter-out load pressure compensating valve 42 as a flow control valve becomes higher in appearance than the actual return flow at the rod side 25r of the stick cylinder 25, the aforementioned actual return flow being dependent on the maximum flow of the hydraulic pump 28. Therefore, in this state, the stick-in meter-out load pressure compensating valve 42 functions as a regular throttle valve and performs meter-out flow control with normal throttling because its ability for compensating for the pressure at the rod side 25r of the stick cylinder 25 does not function.

In other words, should the load pressure at the head side 25h reach a predetermined high level under a heavy load, the embodiment calls for increasing the set load of the spring 63 to such a level that the function of pressure compensation is deactivated, thereby enabling the stick-in meter-out load pressure compensating valve 42 to perform meter-out flow control with normal throttling.

Force modulation function for hydraulic actuators not shown in FIG. 1 or FIG. 2, such as travel motors 11,12, a swing motor 13, and a bucket cylinder 26, is maintained.

### INDUSTRIAL APPLICABILITY

The present invention is applicable to a control circuit for a construction machine with a work equipment, such as a hydraulic shovel.

1. A control circuit for a construction machine, said control circuit comprising an open center circuit including center bypass lines passing through at least a boom operating valve, a stick operating valve, and a bucket operating valve that control hydraulic fluid fed from hydraulic pumps to boom cylinders, a stick cylinder, and a bucket cylinder and subsequently returned through return lines to a tank, said boom cylinders operate a boom, said stick cylinder operate a stick connected to a distal end of said boom, and said bucket cylinder serving to operate a bucket connected to a distal end of said stick, wherein said control circuit further includes:
a pressure-compensating flow control valve provided on a return line for hydraulic fluid returned from a rod side of said stick cylinder to said tank;
a pressure sensor for detecting pressure of hydraulic fluid fed to a head side of said boom cylinders; and
a pressure control valve for controlling a portion of the center bypass line that passes through said boom operating valve so as to increase the pressure in accordance with an increase in the pressure detected by said pressure sensor, said portion being downstream from said boom operating valve.

2. A control circuit for a construction machine as claimed in claim 1, wherein said control circuit further includes:
a pressure sensor for detecting pressure of hydraulic fluid fed to the rod side of said stick cylinder; and
a pressure control valve for controlling a portion of the center bypass line that passes through said stick operating valve so as to increase the pressure in accordance with an increase in the pressure detected by said pressure sensor, said portion being downstream from said stick operating valve.

3. A control circuit for a construction machine as claimed in claim 1, wherein:
each pressure control valve is integrated with an orifice and a relief valve so as to form a negative flow control load pressure compensating valve, said orifice and relief valve serving to retrieve negative flow control pressure from the corresponding center bypass line in order to control pump discharge rate.

4. A control circuit for a construction machine as claimed in claim 1, wherein said pressure-compensating flow control valve further comprises:
a spring for setting a differential pressure; and
a pressure compensation deactivation portion that serves to increase set load of said spring in accordance with increase in load pressure applied to said head side of said stick cylinder, and, when the load pressure to said head side is a predetermined level or higher, increase the set load of said spring to such a level as to deactivate pressure compensation of flow control.

5. A control circuit for a construction machine as claimed in claim 2 wherein:
each pressure control valve is integrated with an orifice and a relief valve so as to form a negative flow control load pressure compensating valve, said orifice and relief valve serving to retrieve negative flow control pressure from the corresponding center bypass line in order to control pump discharge rate.

6. A control circuit for a construction machine as claimed in claim 2, wherein said pressure-compensating flow control valve further comprises:
a spring for setting a differential pressure; and a pressure compensation deactivation portion that serves to increase set load of said spring in accordance with increase in load pressure applied to said head side of said stick cylinder, and, when the load pressure to said head side is a predetermined level or higher, increase the set load of said spring to such a level as to deactivate pressure compensation of flow control.

7. A control circuit for a construction machine as claimed in claim 3, wherein said pressure-compensating flow control valve further comprises:
a spring for setting a differential pressure; and a pressure compensation deactivation portion that serves to increase set load of said sprint in accordance with increase in load pressure applied to said head side of said stick cylinder, and, when the load pressure to said head side is a predetermined level or higher, increase the set load of said spring to such a level as to deactivate pressure compensation of flow control.

8. A control circuit for a construction machine as claimed in claim 5, wherein said pressure-compensating flow control valve further comprises:
a spring for setting a differential pressure; and a pressure compensation deactivation portion that serves to increase set load of said spring in accordance with increase in load pressure applied to said head side of said stick cylinder, and, when the load pressure to said head side is a predetermined level or higher, increase the set load of said sprint to such a level as to deactivate pressure compensation of flow control.
